(19) United States
(12) Patent Application Publication
(10) Pub. No.: US 2010/0299392 A1
(43) Pub. Date: Nov. 25, 2010

(54) Method for controlling remote devices using instant message

(76) Inventor: Shih-Chien Chiou, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,679

(22) Filed: May 19, 2009

(51) Int. Cl. G06F 15/16

(52) U.S. Cl. 709/206; 709/227

(57) ABSTRACT

A method for controlling remote devices using an instant message is disclosed. The invention is to receive messages from the remote network devices, which are monitored through an instant messaging protocol. The instant messaging software, such as the MSN messenger, is used by a user receiving the messages. The user uses a MSN chat window to send commands to the remote devices and request a response. Preferably a step to establish a connection between a connection apparatus and the devices to be monitored is used. Next, a network connection for the software is established. Then the software is standby for an incoming message. As the connection apparatus detects message sent from the devices, the message is transmitted to the user and the software after translation. Moreover, the user can issue commands to the connection apparatus through the software, and the device's operational status is fed back via a chat window.

### BACKGROUND OF THE INVENTION

1. Field of the Invention

The present invention generally relates to a method for controlling remote devices using an instant message, more particularly to use an instant message made through instant messaging software to monitor the remote devices via network.

2. Description of Related Art

Since network communication is well developed, many applications have therefore been disclosed that not only uses network to communicate but also for remote monitoring. Furthermore, due to network proliferation, it becomes very convenient to monitor device remotely. Such schemes have been disclosed in the prior arts. This includes using a network video camera to remotely monitor the current situation in the house, and to acquire the operational status of each remote device.

Reference is made to FIG. 1, which shows a schematic diagram of a remote surveillance system. The system respectively has a monitoring end and an end to be monitored. The device at the monitoring end is a network 10 connected computer 12. At the end to be monitored is a network camera consisting of a camera 16 and a camera control unit 14. Both ends are connected to the network 10 through some network devices (not shown). Users can use the computer 12 to watch the pictures captured by the camera 16 via network. The camera control unit 14 includes a control circuit 141 and a network server 143. The control circuit 141 uses signals to control the camera's (16) operation, this includes but not limited to image process. The network server 143 can then transmit these imaging signals to the network 10.

The user can not only use a computer software to view images received from the network camera but can also use this method to receive various information from remote devices.

The above arts allow users to transmit control signals, from the local computer to the remote devices to be monitored, via network. A web interface is provided for controlling or monitoring these devices.

More applications can be made to include remote monitoring by utilizing different network environments, such as 3G, 3.5G or the like.

### SUMMARY OF THE INVENTION

In view of the above-described arts regarding remote monitoring through a specific web interface, or a proprietary program, the present invention provides a method for controlling remote devices using an instant message. A connection apparatus connected to the network devices particularly has a network module, in which a communication protocol in conformity with an instant messaging protocol is installed. Through the protocol, the status for each device connected with the connection apparatus can be transmitted out. More particularly, the user can use the instant messaging software to monitor the remote devices.

The preferred embodiment of the connection apparatus of the invention is a power strip with multiple sockets which can connect to the plural devices. The mentioned network module is installed in the power strip. When a house is prepared with a network environment, the claimed method using the instant messaging software can be applied to the household appliances, especially when no failover mechanism is available.

In an exemplary example, the messages sent from the connection apparatus can be the signal of a fire accident, the signal of gateway monitoring, the signal of temperature observation, the signal of camera, and the signal of smoke alarm.

The preferred embodiment of the invention is to use a connection apparatus capable of instant communication to retrieve the signals from each device to be monitored. The instant messaging protocol is used to transmit the signals.

A plurality of surveillance facilities and the switch-controlled devices, which are electrically connected to the connection apparatus via input/output ports, are initiated in the beginning. After that, the instant messaging connection is activated, and a preset friendly list is downloaded in the meantime.

While it standby for incoming message, it will determined whether or not any network device to be monitored or any user sends any message. If the message transmitted from the devices to be monitored comes, the message is translated to understandable information, and used to be the sent-out instant message. If the message is sent from the user through the instant message software, the message is translated, by a driver or other compiler, to be readable command. The corresponding response is created thereof.

One of the objectives of the present invention is to employ the instant messaging protocol. Thus the user can use the instant messaging software to receive the message transmitted from the remote devices, or send out related command to the remote devices through a chat window. Any response or request after that passes through the software.

### BRIEF DESCRIPTION OF THE DRAWINGS

FIG. 1 shows a schematic diagram of a conventional remote surveillance system;

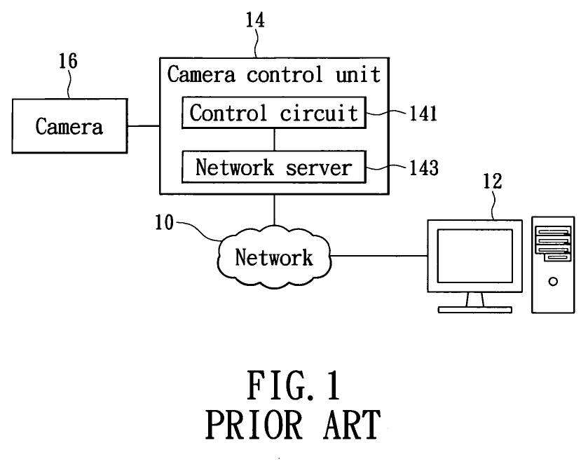

FIG. 2 shows a functional diagram of the preferred embodiment of an apparatus employing the method for controlling a remote device through instant message;

FIG. 3 shows a functional block of the connection apparatus of the present invention;

FIG. 4 is a schematic diagram showing the example using the method for controlling the remote devices of the present invention;

FIG. 5 shows a schematic diagram of creating the control command by the claimed method;

FIG. 6 shows a flowchart of the method for controlling remote devices using instant message of the present invention;

FIG. 7 shows another flowchart of the method for controlling remote devices using instant message of the present invention.

### DETAILED DESCRIPTION OF THE PREFERRED EMBODIMENTS

Due to the well developed network communication technologies, a lot of related applications have come forth. Besides the ordinary text, audio/video, and telecommunication, users can further monitor the remote devices via network. Users can acquire the remote devices' operational statuses by step of process monitoring via the network. It's different from the conventional method that utilizes a web page or the proprietary software to monitor the remote devices, the present invention employs an instant messaging technology to process the monitoring. In which, the user uses instant messaging software to achieve monitoring of the remote devices through the bidirectional interactive commands from an end over network. For example, the messages generated from the devices to be monitored can be a signal of a fire accident, a signal of gateway monitoring, a signal of temperature observation, a signal of camera, and a signal of smoke alarm. Most of these messages relate to household security, but it does not limit the scope of the claimed invention.

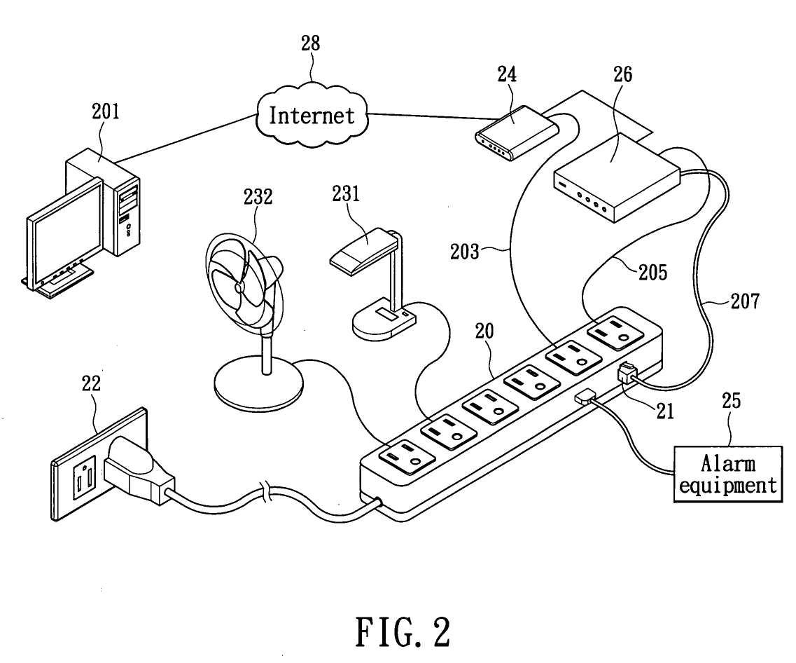

More particularly, for household use (but not limited), the mentioned connection apparatus is used to connect with many kinds of devices to be monitored. The apparatus can be a power strip with multiple sockets. Reference is made to FIG. 2 showing a schematic diagram of the apparatus using the claimed method. The shown connection apparatus 20 is the power strip with multiple sockets. One end of the power strip connects to a power outlet 22 which is a source supplying public electric power. The electric power is supplied to the devices connected with the connection apparatus via the multiple sockets. The present invention uses the power lines interconnected with the connection apparatus and the devices to transmit the control signals. For example, through the power lines, the user may electrically switch the devices. Referring now to the diagram, the connection apparatus 20 connects to the switch-controlled devices, such as the illumination device 231 and the electric fan 232. The devices' switches can be controlled through the instant message. The connection apparatus 20 has an I/O port 21. One end of the apparatus 20 is used to connect the network devices, such as the modem 24 and router 26, via a network line (RJ-45 is preferred) over a connection 207. Thereby, the apparatus 20 can link to Internet 28.

Alternatively the apparatus 20 can connect to multiple peripheral devices via the I/O port 21, for example, the network ports are used to connect to network-ready devices. Other I/O ports, such as USB, ADIO, RS232, RS422, and RS485, are used to link to the other devices such as the alarm equipment 25. The user may control those devices connected to the network through the instant message by this invention.

In order to achieve the instant messaging technology on the present invention, a network module is particularly installed in the connection apparatus 20. The network module is provided to connect to network. Further, an instant messaging protocol module in conformity with a specific communication protocol, such as ICQ, MSN, Yahoo messenger, and Skype, is deployed to provide the instant messaging services. The instant messaging protocol module can be a program embedded in a web browser, for example, Internet Explorer (IE) or Mozilla Firefox may embed the protocol module.

In an initialized procedure, an account for instant messaging service is required to register a virtual character and a contact list is added. The characters desired to be contacted with should install the corresponding instant messaging software with the same standard. Through a chat window of the software, the operational status of the devices connected to the connection apparatus 20 can be sent out. Furthermore, the specific interactive syntax can be used to acquire the remote devices' operational statuses, or to monitor the remote devices via the instant messaging software.

Reference is made to FIG. 2 showing a network environment using the regular ADSL. One or more I/O ports 21 are deployed with the connection apparatus 20. The I/O ports can be used for connecting to a modem 24, such as ATU-R, and a network router 26 via a network line. Moreover, the I/O ports of the present invention can supply power to the modem 24 and the network router 26. Via the I/O ports 21, the peripherals, such as a warning equipment 25 or the network router 26 shown in the figure, connect to the connection apparatus 20. The peripherals can be monitored through the connection apparatus 20 over the network. Moreover, the electric switches of devices can be controlled via the apparatus 20. The signals generated by the devices can be transmitted over the network by a driving module of the connection apparatus 20.

In the preferred embodiment, the user uses the instant messaging * software in a remote computer 201 to connect to the connection apparatus 20. Information transmitted from the connection apparatus 20 can be obtained via a chat window of the software. The information can be the operational status of the network devices 24, 26 connected with the network. Further, the operational status of the devices 25 to be monitored can be obtained through the I/O ports of the apparatus 20. Furthermore, the information such as the operational status of the switch-controlled devices electrically connected to the connection apparatus 20 can be retrieved. For instance, the message from an alarm equipment 25 can be obtained via the chat window when it's alarming.

Particularly, the network module of the mentioned connection apparatus 20 further supports the wireless communication protocol, and connects to the network devices by wireless communication. By way of the network module, the apparatus 20 can connect to Internet 28.

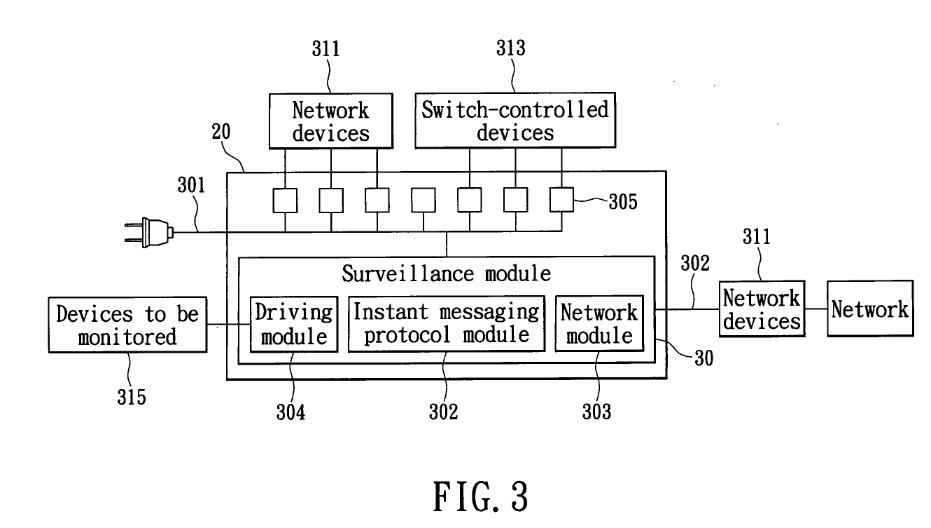

One major objective of the present invention is to monitor the devices connected with the connection apparatus 20 through the instant messaging protocol. A surveillance module 30 is deployed with the connection apparatus 20, and shown as the block diagram of FIG. 3.

The connection apparatus 20 shown in FIG. 3 includes a plurality of outward links. The outward links include an electric connection 301 to a power supply, and a network connection 303 to network. The network devices 311 are preferably connected to the apparatus 20 via the network ports. The devices 315 to be monitored can connect to the apparatus 20 via USB, RS232 or the like. The network can be a local area network, or Internet to which the network devices are connected. The connection apparatus 20 further has multiple sockets 305 that are used to connect the appliances. More particularly, the apparatus 20 not only supplies power to those network devices 311 and the switch-controlled devices 313, but also provides a control mechanism to control their electric switches.

The connection apparatus 20 particularly includes the circuit in charge of connecting network and processing monitoring. In an exemplary example, the surveillance module 30 is deployed with the apparatus 20. The surveillance module 30 functionally at least includes a driving module 304, an instant messaging protocol module 302, and a network module 303.

The driving module 304 is used for providing drivers to the network devices the devices to be monitored, or the switch-controlled devices. By means of the driving module 304, the messages transmitted among the interconnected devices can be translated. For example, the messages sent from the devices to be monitored, through the instant messaging software, are translated into the readable information by users.

The instant messaging protocol module 302 can be a software module, which includes the instant messaging program in conformity with every type of instant messaging protocols. Through the instant messaging protocol module 302, the users may practice the bidirectional messaging by producing instant messages via the instant messaging software. Furthermore, the network module 303 is used to function networking. Beside the well-known ADSL, other wired or wireless networking is supported by the invention.

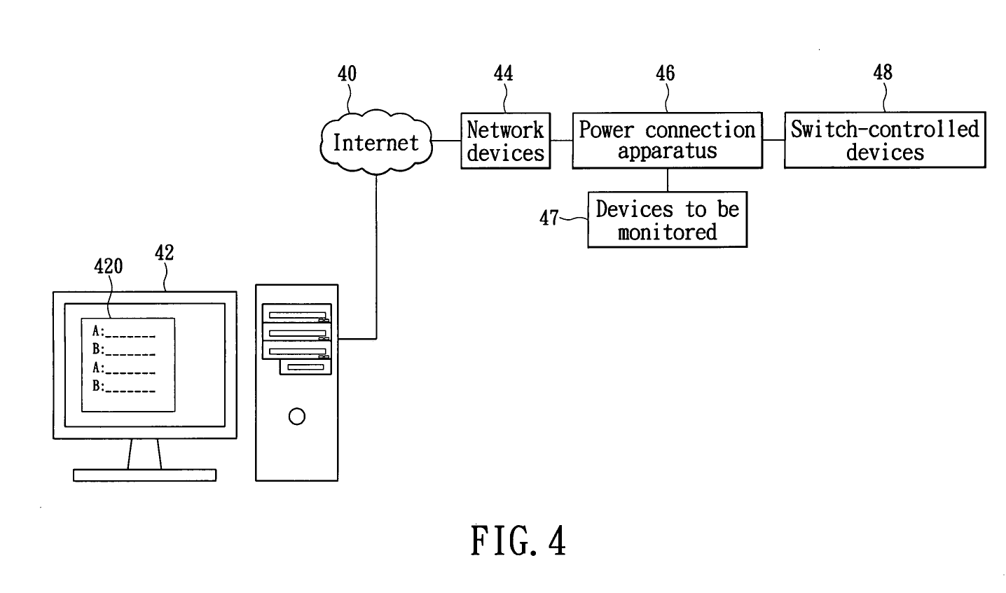

Reference is made to FIG. 4, which shows a schematic diagram of the embodiment using the claimed method for controlling remote devices. An example of two ends of the devices connected to Internet 40 is shown in the figure.

The above-described connection apparatus can be a power connection apparatus 46 shown in the figure. Preferably this power connection apparatus 46 is an independent device connecting to each switch-controlled device 48 and each device 47 to be monitored. The connection apparatus can be a power strip with multiple sockets that connect to the network devices 44, devices 47 to be monitored, and the switch-controlled devices 48. Furthermore, the power connection apparatus 46 can link to Internet 40 via the network devices 44, or directly to other local area network. Especially, the devices 47 to be monitored connect to the apparatus 46 via some types of I/O ports. Therefore, users may remotely perform monitoring process or control the switches through the power connection apparatus 46.

Since the claimed power connection apparatus 46 employs the instant messaging protocol to process the instant messaging, it is necessary to configure a virtual character on the instant messaging software for the apparatus 46. Such as the widespread MSN messenger, the user needs an account to enter a MSN domain. The mentioned instant messaging protocol module records a logon account and the related authentication information. After initialization of entrance, the apparatus 46 automatically logs on to an instant messaging server. A user list is then downloaded after authentication.

The account can be configured by a user during initialization. Following scheme illustrates an embodiment of the present invention.

It's featured that the power connection apparatus 46 can function as a WWW server. The users may enter a web-based configuration page through a web browser. By way of network connection, a registered account and password for the instant messaging software are required to save to a memory (not shown) of the power connection apparatus 46. Further, a user list for instant messaging is settled. In the meantime, the characters that need to receive the messages transmitted from the apparatus are added into the list. If any message is generated, the signals will be transmitted to the characters in the user list.

Reference is made to FIG. 4. Instant messaging software 420 initiates as a user uses a computer 42 at an end of network. An Account representing the power connection apparatus 46 is added in the user's list. After that, the user may connect peer-to-peer to the power connection apparatus 46. One of the embodiments is to passively wait for the messages from the power connection apparatus 46 via Internet 40 or the local area network. After translation made by the apparatus 46, the messages transmitted from the devices 47 to be monitored through the apparatus 46 can be readable to the user. In which, a chat window is provided by the software 420 for reviewing the messages.

Alternatively, a syntax via the chat window can be actively used to acquire the messages. By way of interactive commands, the power connection apparatus 46 acquires the messages. Those commands can be translated preferably by a driver, such as a command interpreter. The user actively sends messages to the account standing for the power connection apparatus 46. Then the apparatus 46 receives the user's messages, and responds to the user. Those interactive messaging activities achieve the object of switch-controlling or remote monitoring.

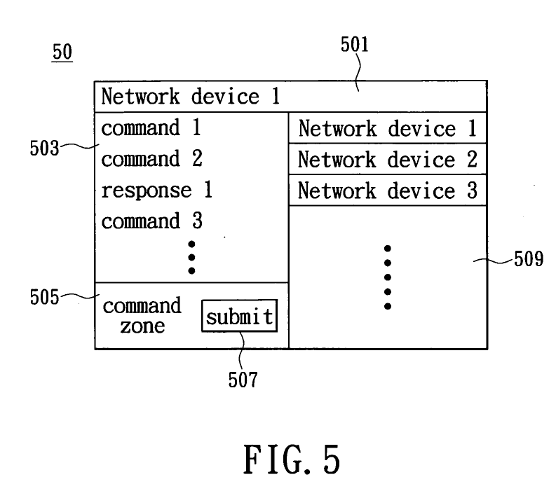

The mentioned chat window of the instant messaging software is shown in FIG. 5. The figure shows an exemplary diagram of the control commands generated by the instant messaging software. The user interface of the instant messaging software 40, such as MSN messenger, has several separated zones. A zone 501 is used for displaying the list. A network device 1 is exemplarily shown on the list. This network device 1 can be one of the devices connected with the power connection apparatus via a network port.

A zone 503 is used to display an interactive window. In this example, the zone 503 shows several interactive commands, such as command 1, command 2, response 1 and command 3, between the user and the network device 1.

A zone 505 is used to input commands. The user can input the desired commands to send to the network device 1. A submit button 507 is used to transmit the instant message.

Further, a side bar of the user interface is a zone displaying the online devices to be monitored, including the network device 1, network device 2, and network device 3 in an exemplary example.

Referring to the diagram, at least three network devices to be monitored are listed on the instant messaging software 50 at the same time. Through the instant messaging software, the user may send every kind of commands to the devices listed on the zone 501, and wait for response. Moreover, the interactive commands can be used to control the switches of the devices connected to the power connection apparatus.

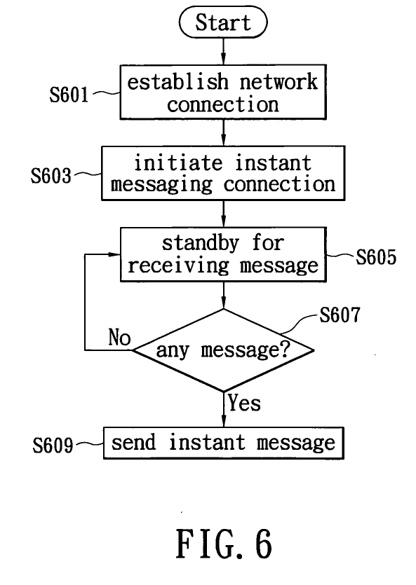

According to the above-described embodiments of the method, the flowchart shown in FIG. 6 illustrates the preferred steps.

In the beginning, the claimed connection apparatus is initiated. Further, the devices to be monitored connected to the apparatus are also initiated. In order to achieve the remote monitoring, the connection apparatus needs a driver for the devices. The driver is not only used to translate the commands and messages, but also used to control the operation for each device. For example, in order to shut down the devices, the user can transmit a shutdown command to the devices that are monitored through the software. More, the user can also configure the operation for each device remotely.

After initiation, the devices to be monitored are initialized and the network connection to the devices is established. After that, the apparatus initiates the instant messaging protocol module, and completes the instant messaging connection (step S601). The network allows the connection apparatus to connect to the Internet or a local area network via the network devices.

Next, the connection apparatus initiates an instant messaging connection (step S603) particularly through the instant messaging protocol module. The instant messaging connection is now established thru the network module. Once the instant messaging connection is established, the user can then use the software to build the peer-to-peer connection to one or more characters in the list. Usually, the instant messaging service provider will authenticate the user first, and then provide the user list to be downloaded.

After establishing the instant messaging connection, the software establishes the peer-to-peer connection with the listed accounts. The characters on the list will standby for monitoring, and waits for further messages (step S605). While it waits for further messages (passive mode), the connection apparatus stands-by to receive the messages from the devices to be monitored. It will determine whether or not any message has been generated (step S607). If a message has been generated, an instant message is then sent in step S609.

For example, a message is generated by the devices to be monitored, and transmitted through the instant messaging connection. The messages can be the signal of a fire accident, the signal of gateway monitoring, the signal of temperature observation, imaging signal of camera, and the signal of smoke alarm. The messages can be transmitted to all characters or selected characters from the list in the instant messaging software. Furthermore, the message can be the response to the user's request.

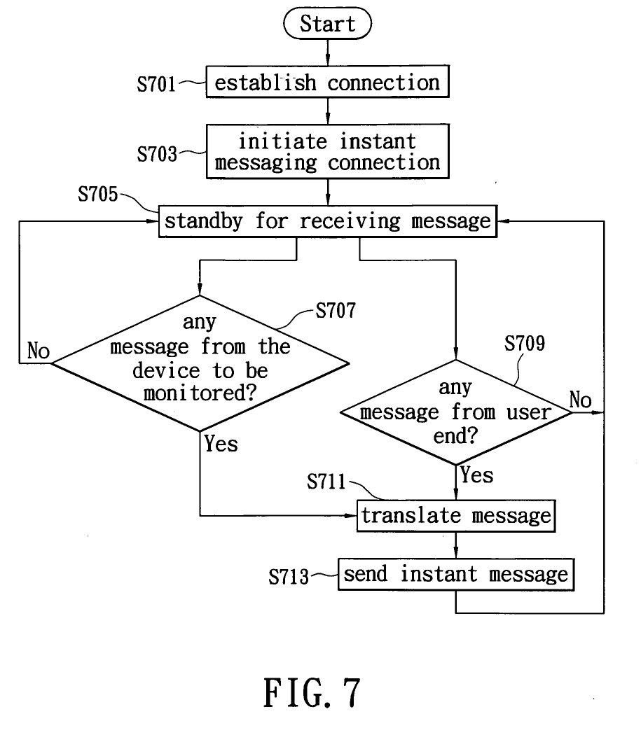

FIG. 7 shows a flowchart of the embodiment of the present invention.

Firstly, the devices to be monitored that are connected to the connection apparatus are initiated. The network connection for the devices is then established (step S701). Next, the instant messaging connection is initiated (step S703). The steps to establishing a connection is logon to an instant messaging server, download a user list after authentication, and standby to receive messages (step S705).

In the meantime, the connection apparatus capable of instant messaging is on standby for monitoring or receiving the devices' messages, or signals from the listed characters. In step S707, the mentioned standby procedure is also to determine whether there are any messages transmitted from the devices to be monitored. If there are no messages, it will continue the standby procedure in step 705. If a message is received, the message is first translated to readable information (step S711). Then the information is transmitted (step S713) to the listed characters, or any desired receiver except for the unrelated ones. After that, the method goes back to the standby procedure in step S705.

In the standby procedure, it also determines whether there is any message from the user end (step S709). Through the instant messaging software, the message can be a bidirectional interactive command. The connection apparatus responds a corresponding instant message upon receiving the message.

If no message is transmitted from the listed character, it will return to the standby procedure in step S705. If a message is transmitted through the instant messaging software, the driver or other compiler will be used to translate the message into readable information (step S711). After translation, an instant message is generated and sent out (step S713). The recipient can be selectively assigned from the listed characters.

In summation of above description, the claimed method for controlling the remote device using the instant message is provided to transmit message through the instant messaging software. The user can also receive the message transmitted from the remote devices to be monitored through the software. Particularly, a chat window is used to transmit the interactive command, and further request the related response.

Furthermore, the user may transmit a command via the chat window of the instant messaging software. The interactive command is used to acquire the operational status of the device to be monitored through the claimed connection apparatus. The operational status can be the operation temperature, system loading, or system status. More, the user may thru the instant messaging protocol maintain the operations of the remote device.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A method for controlling a remote device using an instant message, comprising:
establishing a network connection to a power connection apparatus, wherein the apparatus connects to one or more devices to be monitored via one or more I/O ports;
initiating an instant messaging connection, and processing an authentication in an instant messaging server, and downloading a list;
standby for receiving signals from one or more devices; and
when a signal is generated, the signal is transmitted as the instant message to one or more receivers, wherein each receiver uses instant messaging software to receive the instant message.

2. The method of claim 1, wherein one or more peer-to-peer connections are established to link one or more characters from the list after initiating the instant messaging connection.

3. The method of claim 1, wherein the devices to be monitored connect to the network through the power connection apparatus having an instant messaging protocol module installed.

4. The method of claim 3, wherein the power connection apparatus is in conformity with an instant message protocol, thereby to initiate the instant messaging connection.

5. The method of claim 4, wherein the instant messaging protocol module is a software module, therein a plurality of instant messaging programs are in conformity with every type of instant messaging protocols.

6. The method of claim 3, wherein the power connection apparatus is a power strip with multiple sockets.

7. The method of claim 3, wherein the power connection apparatus includes a network module for establishing the network connection.

8. The method of claim 1, wherein after the message is generated by the device to be monitored is translated, a receiver-understandable instant message is created and displayed on a chat window after transmission.

9. The method of claim 8, wherein the power connection apparatus translates the message through a driving module.

10. The method of claim 1, wherein the power connection apparatus electrically connects to switch-controlled devices via power lines.

11. A method for controlling a remote device using an instant message, comprising:
establishing a network connection for a power connection apparatus, wherein the power connection apparatus connects to one or more devices to be monitored via one or more I/O ports, and the power connection apparatus has an instant messaging protocol module, by which the devices connect to network;
initiating an instant messaging connection, and logging on an instant messaging server, and downloading a list after authentication;
standby for receiving a message, wherein the message includes the message transmitted from each device, and sent from a plurality of listed receivers through an instant messaging protocol;
if there is the message transmitted from the device, an instant message is transmitted to the listed receivers after translation;
if there is the message sent from any receiver through instant messaging software, the message is converted to a readable command after translation; and
responding a further instant message.

12. The method of claim 11, wherein the message sent from the receivers via the instant messaging software is a bidirectional interactive command, another instant message is responded since the receivers receive the message.

13. The method of claim 11, wherein one or more peer-to-peer connections are established to link one or more listed receivers after the step of initiating the instant messaging connection.

14. The method of claim 11, wherein the power connection apparatus is in conformity with the instant messaging protocol, thereby to initiate the instant messaging connection.

15. The method of claim 11, wherein the instant messaging protocol module is a software module, which installs a plurality of instant messaging programs in conformity with every type of instant messaging protocols.

16. The method of claim 11, wherein the power connection apparatus has a network module, thereby to establish the network connection.

17. The method of claim 11, wherein the power connection apparatus translates the message through a driving module.

18. The method of claim 11, wherein the power connection apparatus is a power strip with multiple sockets.

19. The method of claim 11, wherein after the message generated by the device to be monitored is translated, a receiver-understandable instant message is created and displayed on a chat window after transmission.

20. The method of claim 11, wherein the power connection apparatus electrically connects to one or more switch-controlled devices via power lines.
